(19) United States
(12) Patent Application Publication
(10) Pub. No.: US 2020/0208628 A1
(43) Pub. Date: Jul. 2, 2020

(54) Quad-Quint Pump Systems and Methods

(71) Applicants: Axel Michael Sigmar, Lago Vista, TX (US); Leland Modoc, Lago Vista, TX (US)

(72) Inventors: Axel Michael Sigmar, Lago Vista, TX (US); Leland Modoc, Lago Vista, TX (US)

(21) Appl. No.: 16/384,895

(22) Filed: Apr. 15, 2019

Related U.S. Application Data
(60) Provisional application No. 62/657,336, filed on Apr. 13, 2018.

(51) Int. Cl. F04C 11/00; F04C 2/04; F04C 14/02

(52) U.S. Cl. CPC F04C 11/008; F04C 2/04; F05B 2240/40; F04C 2240/402; F04C 14/02

(57) ABSTRACT

A pump system may include a plurality of motors coupled to a shaft and configured to cause the shaft to rotate, and a power end coupled to the shaft. The power end may include a plurality of yoke frames, each of which may include one or more push rods. The pump system may further include multiple fluid ends coupled to the power end. Each fluid end may include a cylinder chamber including a piston-plunger assembly configured to couple to one of the one or more push rods of the power end. The pump system may also include a device to disconnect or isolate one or more of individual piston assemblies, or one or more of the multiple fluid ends. The pump system may also include a multiplicity of controllers which may enhance performance, reliability, and operating life in a number of modes and conditions in a health management method.

### FIELD

The present disclosure is generally related to pump systems, and more particularly to integrated electrical pump systems configured to deliver fluid to a fluid outlet at a selected pressure and volume. One particular implementation of the pump system may pump fracking fluid, other fluid mixtures, slurries, or mixtures of fluids and gases, for example, for oil field use.

### BACKGROUND

A pump is a mechanical device that is often used to move various fluids or slurries within a system. Further, multiple pumps can be utilized in parallel arrangements to facilitate scaler system requirements or provide uninterrupted system redundancy. Most high-pressure pumps operate via reciprocating motion in conjunction with various mechanical valves. Whereby fluid is drawn into a cylinder via the displacement of a piston or plunger through an open inlet valve. By changing the piston or plunger's direction in the cylinder, via reciprocating motion, differential pressure in the cylinder closes the inlet valve and forces the fluid through at least one outlet valve. This process is repeated many cycles in short period of time producing fluid movement across the system. Such mechanical systems are often driven by some form of prime mover connected to a rotary-to-linear motion device via an intermediary gear train.

In some examples, pumps can be used in a variety of systems including, but not limited to, hydraulic fracturing, drilling mud, sand dredging, fire suppression, gas compressors, cement or concrete, other systems, or any combination thereof. Piston pumps can be powered by any number of prime movers including, but not limited to, internal combustion engines, direct current (DC) electric motors, alternating current (AC) electrical motors, linear electric motors, turbines, or any combination thereof.

Systems incorporating high power prime movers generally require selectable transmissions operating in concert with reduction gear trains. These gear systems are necessary to provide the required high torque at the low speeds which loads, such as pumps, compressors, grinders, propellers and some other devices, operate. The axial length and weight of these prime movers is often exacerbated by the additional length and weight of the gear systems. Efficiency is lost in the reduction train which in turn takes the form of heat, increasing the need for additional lubrication and cooling resources. At each incremental reduction, increases in system cost and maintenance are incurred while reducing system reliability.

In some high-power systems, the prime mover operates at high rotational speeds to achieve a high power density, but when the load using this power must operate at range of low rotational speeds, or torque requirements several factors higher than the motor can produce, the reduction gear train reaches a number of limits including bearings and strength of materials, necessitating further system fragmentation, which in turn compounds the efficiency losses and introduces control system complexities.

### SUMMARY

Embodiments of systems and methods may include a Quad Quint (QQ) pump system. The QQ pump system may include a multiplicity of low speed, high torque direct drive electrical motors, which may drive a multiplicity of banks of positive displacement pistons through fixed cylinders called fluid-ends, through a novel rotary to linear conversion mechanism, referred to as a power-end. In one embodiment, the QQ pump system may include a combination of a plurality of motors, driving the power end to supply four fluid-ends containing five cylinders each, hence the designation of “Quad Quint.” The combination of pressure and flow-rate output from the fluid-ends may define a primary specification in terms of hydraulic horsepower (HHP). The QQ pump system may be configured to deliver more than 21,000 HHP in a single unit measuring approximately 108×160×72 inches and weighing less than 80,000 lbs. There are many benefits and advantages derived from the compact nature of the system.

One particular advantage includes the relatively low maintenance requirements of the direct drive motors and the power-end, especially compared to the number of large diesel engines, transmissions, reduction gears and conventional power-ends replaced hereby. Further, the QQ pump system may include a distributed system controller that may enable local, fast control of individual components. Additionally, the QQ pump system may provide for fail-over, fault management, and dynamic load balancing, allowing the system to maintain consistent output pressure, even when individual pump components fail and are selectively deactivated. Other embodiments are also possible.

In some embodiments, a QQ pump system may include a shaft configured to rotate and a plurality of motors coupled to the shaft and configured to cause the shaft to rotate at a selected rate. The QQ pump system may further include a pump including a plurality of banks of positive displacement pistons coupled to the shaft and configured to convert rotational motion of the shaft to linear motion of each positive displacement piston of the plurality of banks of positive displacement pistons. The QQ pump system may further include a QQ system controller coupled to the plurality of motors to control operation of each of the plurality of motors.

In some embodiments, the QQ pump system may include a plurality of distributed processing circuits, such as within circuit wedges, each of which may include one or more of the stator coils of a stator assembly. In some implementations, each circuit wedge may receive sensor signals and adjust operation to enhance performance in response to receiving the sensor signals. Further, the distributed processing circuits may be configured to communicate with one another (for example, between wedges, between motors, between pump control processors, between the processing circuit and a system level control system, and so on). Further, the QQ pump system may include a plurality of fluid end controllers, which may be configured to control the isolation and disconnect functions of the fluid end and to manage data received from various sensors. The distributed processing circuits may be further configured to manage performance at a selected level within the system, while selectively altering performance at each coil or within each circuit wedge, independently, which granularity of control may enhance overall performance and extend the life cycle (usable life) of system components and the system as a whole by managing the health of the system at all levels.

In one possible embodiment, a pump system may include a power end, a plurality of fluid ends coupled to the power end, and a system controller. The power end may include a plurality of yoke frames. Each yoke frame may include one or more push rods. Each fluid end may include a cylinder chamber and a piston-plunger assembly within the cylinder chamber. Each piston-plunger assembly may couple to a push rod of one of the plurality of yoke frames. The system controller may selectively unload one or more of the plurality of fluid ends.

In some implementations, a pump system may include one or more electric motors to drive a shaft, a plurality of transverse frames configured to move back and forth along linear paths perpendicular to the axis of rotation of the shaft, and a plurality of bulkheads, including first bulkheads which may form the ends of the pump and a plurality of intermediate bulkheads between the first bulkheads. The intermediate bulkheads may secure the frames and restrict movement of the frames to linear movements back and forth on a pre-determined path that is perpendicular to an axis of the shaft. At least some of the components of the pump system may be comprised of high modulus composite materials, which reduce weight and provide effective load paths and high stiffness to mitigate vibrations and resonances in the pump system. The pump system may further include tension rods configured to react to the very high transverse oscillatory loads between opposing piston-plunger assemblies and their corresponding fluid ends. The composite components may be utilized to keep the forces balanced in the QQ pump system, allowing for distribution of the load in a way that reduces the weight of the fastening system relative to conventional pumps, while increasing stiffness, attenuating and damping vibrations and harmonics that lead to fatigue and premature failure. In some implementations, the composite material may reduce stretching in the fastening system and increases the rigidity, which further augments vibration and damping characteristics of the QQ pump system. This characteristic may also reduce noise in the sensors.

In some embodiments, a pump system may include a shaft, a plurality of motors coupled to the shaft and configured to cause the shaft to rotate about a longitudinal axis of the shaft, and a power end coupled to the shaft. The power end may include a plurality of yoke frames. Each yoke frame may include one or more push rods. The pump system may also include multiple fluid ends coupled to the power end. Each fluid end may include a cylinder chamber including a piston-plunger assembly configured to couple to one of the one or more push rods of the power end. The pump system may further include one or more devices to independently load or unload one or more of the fluid ends.

In other embodiments, a pump system may include a shaft and one or more motors coupled to the shaft and configured to cause the shaft to rotate about a longitudinal axis of the shaft. The pump system may further include a power end coupled to the shaft. The power end may include one or more push rods. The pump system may also include multiple fluid ends coupled to the power end. Each fluid end may include a cylinder chamber and may include a piston-plunger assembly within the cylinder chamber. The piston-plunger assembly may couple to one of the one or more push rods of the power end. The pump system may also include a controller system coupled to the one or more motors, the power end, and the multiple fluid ends. The controller system may selectively unload one of the multiple cylinders or one of the multiple fluid ends containing a plurality of cylinders.

In still other embodiments, a pump system may include a power end coupled to a shaft. The power end may include a plurality of yoke frames. Each yoke frame may include a plurality of push rods. The pump system may also include a plurality of fluid ends coupled to the power end. Each fluid end may include a cylinder chamber including a piston-plunger assembly to couple to one of the plurality of push rods of the power end via a coupling mechanism. The piston-plunger assembly may include an integrated damping feature to dampen vibration. The pump system may also include a first mechanism to decouple the piston-plunger assembly from the one of the plurality of push rods in response to a cylinder pressure that exceeds a threshold pressure and a second mechanism to isolate the cylinder chamber from at least one of a fluid inlet and a fluid outlet. Further, the pump system may include a system controller to communicate with the power end, the plurality of fluid ends, the first mechanism, and the second mechanism. The system controller may adjust one or more parameters to manage health of the pump system.

### BRIEF DESCRIPTION OF THE DRAWINGS

The detailed description is set forth with reference to the accompanying figures. In the figures, the left most digit(s) of a reference number identifies the figure in which the reference number first appears. The use of the same reference numbers in different figures indicates similar or identical items or features.

FIG. 1 depicts a block diagram of a QQ pump system, in accordance with certain embodiments of the present disclosure.

FIG. 2 depicts a block diagram of control and health management components of the QQ pump system, in accordance with certain embodiments of the present disclosure.

FIG. 3 depicts a block diagram of a portion of a control system of the QQ pump system, in accordance with certain embodiments of the present disclosure.

FIG. 4 depicts a perspective view of a pump system including motors, a power end, and a fluid end, in accordance with certain embodiments of the present disclosure.

FIG. 5A depicts a diagram of a yoke frame assembly of the power end of FIG. 4, in accordance with certain embodiments of the present disclosure.

FIG. 5B depicts a cross-sectional view of the yoke frame assembly of FIG. 5A, taken along line B-B in FIG. 5A.

FIG. 5C depicts a perspective view of the yoke frame assembly of FIG. 5A including a cover, in accordance with certain embodiments of the present disclosure.

FIG. 6 depicts a sectioned perspective view of the QQ pump of FIG. 4 with a portion removed, in accordance with certain embodiments of the present disclosure.

FIG. 7 depicts a cross-sectional view showing a portion of the pump system taken along a line between yoke frames, in accordance with certain embodiments of the present disclosure.

FIG. 8 depicts an exploded view of components of the pump system, in accordance with certain embodiments of the present disclosure.

FIG. 9 depicts a piston-plunger assembly including mechanical disconnect, peak pressure disconnect, and damping mechanism, in accordance with certain embodiments of the present disclosure.

FIG. 10 depicts a flow diagram of a method of controlling a pump system, in accordance with certain embodiments of the present disclosure.

While implementations are described in this disclosure by way of example, those skilled in the art will recognize that the implementations are not limited to the examples or figures described. It should be understood that the figures and detailed description thereto are not intended to limit implementations to the particular form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the work “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

Embodiments of a QQ pump system are described below, which may include integrated low-speed, high torque, direct-drive electric motors configured to drive a multiplicity of banks of positive displacement pistons, called “fluid ends,” through a novel rotary to linear conversion mechanism, referred to as a “power end.” In some embodiments, the QQ pump system may include four electric motors driving five yoke frames, each of which includes four push rods to drive four corresponding piston-plunger assemblies of the fluid-end.

In some embodiments, a QQ pump system may include a shaft configured to rotate and a plurality of motors coupled to the shaft and configured to cause the shaft to rotate at a selected rate. The QQ pump system may further include a pump including a plurality of banks of positive displacement pistons coupled to the shaft and configured to convert rotational motion of the shaft to linear motion of each positive displacement piston of the plurality of banks of positive displacement pistons. The QQ pump system may further include a QQ system controller coupled to the plurality of motors to control operation of each of the plurality of motors.

In some embodiments, the quad-quint pump system includes a plurality of distributed processing circuits, such as within circuit wedges, each of which may include one or more of the stator coils of a stator assembly. In some implementations, each circuit wedge may receive sensor signals and adjust operation to enhance performance in response to receiving the sensor signals. Further, the distributed processing circuits may be configured to communicate with one another (for example, between wedges, between motors, between pump control processors, between the processing circuit and a system level control system, and so on). The distributed processing circuits may be further configured to manage performance at a selected level within the system, while selectively altering performance at each coil or within each circuit wedge, independently, which granularity of control may enhance overall performance and extend the life cycle (usable life) of system components and the system as a whole by managing the health of the system at all levels.

In some implementations, a pump system may include one or more electric motors to drive a shaft, a plurality of yoke frames. The yoke frames may be transverse to a longitudinal axis of the shaft and configured to move back and forth along linear paths perpendicular to the longitudinal axis of the shaft. The pump system may further include a plurality of bulkheads, including first bulkheads which may form the ends of the pump and a plurality of intermediate bulkheads between each of the yoke frames. The intermediate bulkheads may secure the frames and restrict movement of the frames to linear movements back and forth on a pre-determined path that is perpendicular to an axis of the shaft.

At least some of the components of the pump system may be comprised of high modulus composite materials, which reduce weight and provide effective load paths and high stiffness to mitigate vibrations and resonances in the pump system. The pump system may further include tension rods configured to react to the very high transverse oscillatory loads between opposing piston-plunger assemblies and their corresponding fluid ends. The composite components may be utilized to keep the forces balanced in the QQ pump system, allowing for distribution of the load in a way that reduces the weight of the fastening system relative to conventional pumps. Further, axial tension rods, vertical tension rods, and transverse tension rods may cooperate to secure the components within the housing and to balance forces through the frame and housing. In a particular example, the transverse tension rods may extend through a first fluid end, through the intermediate bulk heads, and through the second fluid end and may balance piston pressures while reinforcing the yoke frames and the housing.

The electric motors may drive a shaft, which is coupled to the power end. The power end, the motors, upper and lower crank housings, crank covers, and fluid ends may be held in place by composite tension rods. The composite tension rods may extend through the bulkheads, including end portions and intermediate portions. The configuration reduces the overall weight of the system relative to conventional pumping systems. In one possible example, the composite materials and the composite tension rods may hold the elements together, balance loads and stresses, and reduce the overall weight by as much as 2,500 pounds relative to conventional oil-field pump systems. Other implementations may be even lighter.

The combination of pressure and flow rate output from the fluid-ends defines a primary specification, in hydraulic horsepower (HHP). In a particular example, the QQ pump system may be configured to deliver more than 21,000 HHP in a single unit measuring approximately 108×160×72 inches and weighing less than 80,000 lbs. The compact nature of the QQ pump system enables a number of advantages and benefits, many of which will be apparent to one of skill in the art in light of the following description.

In one example, the direct drive electric motors and the power end are designed to require relatively little maintenance, especially compared to the number of large diesel engines, transmissions, reduction gears, and power ends of a conventional system that the QQ pump system is designed to replace.

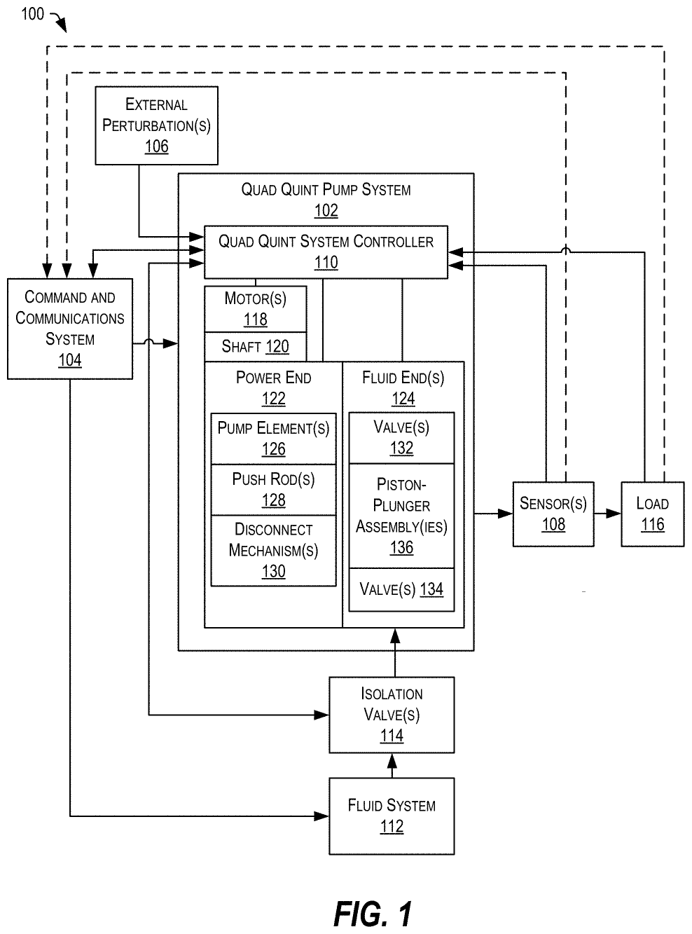

In the following discussion, embodiments of a QQ pump system are described that may include a plurality of motors, a power end including a plurality of banks of positive displacement pistons, and a rotary-to-linear conversion mechanism that includes an eccentric, which simplifies the load path to a direct linear transfer of force to the piston-plunger assembly, dramatically mitigating failures due to wear as compared to the many connecting components of conventional pumping systems. Further, the QQ pump system may include a feedback loop that may include a QQ controller. Additionally, the QQ pump system may be configured to respond to control signals from a system controller as well as adjustments from the QQ controller and to respond to perturbations to the system. One possible example of a QQ system is described below with respect to FIG. 1.

FIG. 1 depicts a block diagram of a system 100 including a QQ pump system 102, in accordance with certain embodiments of the present disclosure. The QQ pump system 102 including an input to receive control signals from a command and communication system 104. The QQ pump system 102 may also include an input to receive external perturbations 106, such as noise, vibration, interference, and various other system influences.

The QQ pump system 102 may include an output coupled to one or more sensors 108. The QQ pump system 102 may include an input or inlet coupled to a fluid system 112 through one or more isolation valves 114. It should be understood that the fluid system 112 represents one possible fluid source, which may deliver a fluid mixture or composition to the QQ pump system 102. In other implementations, the QQ pump system 102 may receive a fluid mixture, such as drilling mud, from a different fluid source. Other implementations are also possible.

The QQ pump system 102 may include a QQ system controller 110, which may be distributed among one or more of the components of the QQ pump system 102. The QQ system controller 110 may further include one or more motors 118 coupled to and configured to rotate a shaft 120. The QQ pump system 102 may further include a power end 122 that is coupled to the shaft and that converts rotary motion of the shaft 120 into linear motion transverse to a longitudinal axis of the shaft 120. Further, the QQ pump system may include a plurality of banks of positive displacement pistons (“fluid ends” 124) coupled to the power end 122.

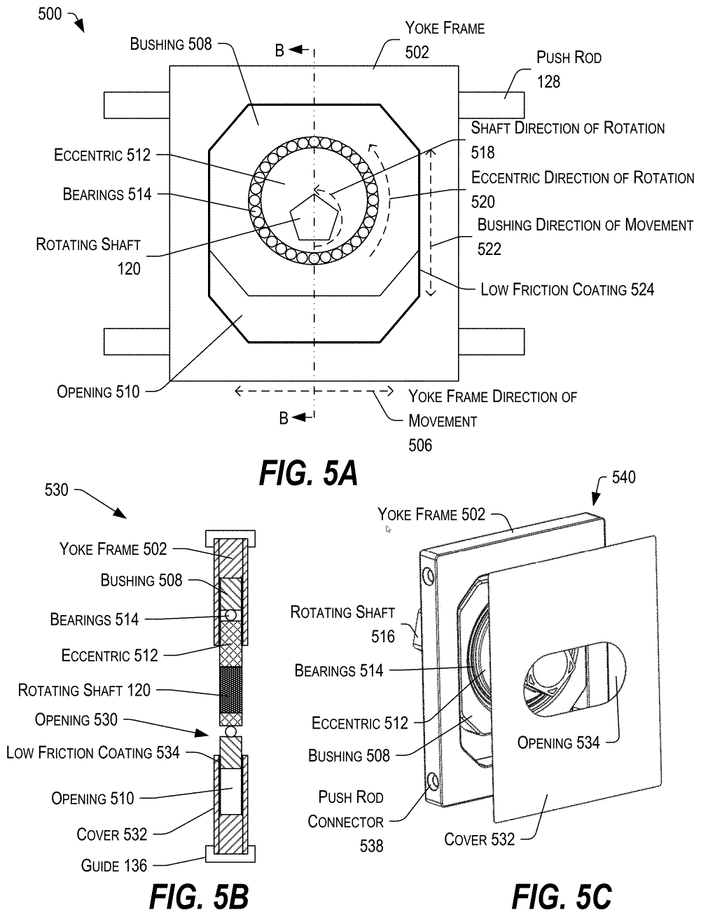

The power end 122 may include a plurality of pump elements 122, which may include a plurality of yoke frames (shown in FIGS. 5-8), each of which may drive a plurality of push rods 128. Further, the power end 122 may include a plurality of disconnect mechanisms 130, which may independently decouple one of the push rods 128 from a corresponding piston-plunger 136 of a plurality of plungers 136 of one of the fluid ends 124.

The fluid ends 124 may include a plurality of inlet valves 132, a plurality of outlet valves 134, and a plurality of plungers 136. Each piston-plunger 136 may be coupled to one of the push rods 128 of the power end 122.

The command and communications system 104 may include one or more hardware processors and one or more memory devices, which may store data and processor-executable instructions. In some implementations, the command and communications system 104 may include one or more input devices (such as keyboards, pointer devices, and other input components) and one or more output devices (such as displays, printers, and so on). Further, the command and communications system 104 may include one or more communications interfaces, including one or more network interfaces, one or more input-output (I/O) interfaces, other interfaces, or any combination thereof.

The command and communications interface 104 may be configured to provide a graphical interface through which an operator may interact with the QQ pump system 102. In an example, the graphical interface may display information about the state of the QQ pump system 102, including flow information, power-related information, information about various parameters (such as temperature, pressure, and so on). Further, the graphical interface may present information about the state of the fluid system 112, including flow information, power-related information, information about various parameters (such as temperature, pressure, and so on). In some implementations, the graphical interface may also present as alerts, such as when one or more parameters of the QQ pump system 102 or the fluid system 112 exceeds a threshold.

The command and communications system 104 may be accessed by a user to view status information associated with the QQ pump system 102, the fluid system 112, a load 116, or any combination thereof. Further, the user may interact with the graphical interface to adjust one or more operating parameters. It should be understood that the command and communications system 104 may be coupled to one or more QQ pump systems 102, one or more fluid systems 112, and one or more loads 116, and may be configured to control operation of the overall system 100 as well as, in some instances, individual components of the one or more QQ pump systems 102, the one or more fluid systems 112, and the one or more loads 116.

In some implementations, the command and communications system 104 may be configured to provide control signals, automatically or in response to operator inputs, which control signals may be provided to the summing node 106 to influence operation of the QQ pump system 102. In a particular embodiment, the command and communication system 104 may be configured to communicate wirelessly using radio frequency signals or via wired connections, such as one or more Ethernet connections, one or more controller area network (CAN) connections, one or more serial connections (such as a universal serial bus (USB) connection or other wired connections), and so on. Further, the command and communication system 104 may be configured to manage security and encryption of data as well as communication signals. The command and communication system 104 may also include a program memory configured to enable control as well as to manage system interrupts.

The QQ system controller 110 may be configured to receive sensor data from one or more sensors 108 associated with the load 108 or coupled to the output of or integrated within the QQ pump system 102 and may generate a feedback adjustment based on a selected mode of operation and based on data determined from the sensor signals. In some embodiments, the QQ system controller 110 may be integrated within the power electronics of the QQ pump system 102. In a particular embodiment, the QQ system controller 110 may be distributed across a plurality of components of the QQ pump system 100. Other embodiments are also possible.

In particular embodiments, the QQ system controller 110 may include distributed processors configured to implement a health management system that monitors and manages the specific outputs of particular system components and the specific output of the requisite load to extend the life of such components.

It should be appreciated that failure management is a secondary effect, in part, because the health management system may detect early signs indicative of potential failures and may produce an alert or other indicator to notify an operator that maintenance may be needed. This capability is referred to herein as “machine health management.” One or more of the processors may be configured to apply analytics to measured parameters, historical data, and other data to determine trends and to predict operational variations. The analytics data may be presented to an operator through the graphical user interface. Trend analysis and reporting allows the user/operator to plan maintenance rather than incur total failure during a pumping operation.

In some implementations, the QQ system controller 110 may receive parameter measurements from the sensors. Such parameters may include temperature, voltage, current, pressure, force, other parameters, or any combination thereof. The QQ system controller 110 may include a plurality of thresholds associated with various components. The difference between the measured parameters and the thresholds may define a reserve capacity. The QQ system controller 110 may monitor the reserve capacity of each of the various components, and may communicate the reserve capacity to other controllers.

In some implementations, the QQ system controller 110 (or one or more its distributed components) may apply certain cost-function optimizations in a distributed or centrally directed manner. The distributed controllers may manage the health, reliability, and life of particular components, and of the machine as a whole, by preventing certain limits from being exceeded locally, unless override commands are received from the operator or central controller. By use of distributed control and sensing and by assessing and communicating reserve capacity, the machine health may be actively managed, providing enhanced (sometimes optimized) performance and efficiency while reducing (minimizing) over temperature or other stresses, and mitigating vibrations. In some implementations, the QQ system controller 110 may receive sensor signals or other detectable indicators of impending failure and may, by shifting the demand requirements to other parts of the system, extend the life of the system, reducing or delaying maintenance.

Further, the power end 122 may be configured to provide selective displacement of the pump elements 126 (such as yoke frames 502 in FIGS. 5-8), which may be utilized to allow for different operating conditions within the same bore set. In some implementations, the QQ system controller 110 may selectively activate or deactivate one or more valves 114, 132, or 134 or may selectively connect or disconnect one or more of the disconnect mechanisms 130 to selectively control operation of the one or more power ends 122 and the one or more fluid ends 124.

In some implementations, machine health management modes and priorities may be applied by the QQ system controller 110 or by user inputs through the command and control system 104, to adjust selected cost functions, or to achieve a selected operation level. In some embodiments, plunger sizes may differ providing different pressures, if that piston-plunger assembly 136 or the fluid end 124 is loaded. Other embodiments are possible.

By selectively and independently controlling the various components and the operation of the QQ pump system 102, the QQ system controller 110 has secondary effect of managing the QQ pump system 102 so that it has the ability to operate in the event of clogs, sanding, or mechanical failure of upstream components, such as valves, allowing the QQ pump system 102 to operate despite multiple partial failures, while informing the user/operator of its status, remaining capacity, and predicted service life via the command and communication system 104.

A multiplicity of QQ systems 102 may be employed (integrated) within a larger system. The command and communications system 104 may be configured to manage capabilities between multiple QQ pump systems 102, making it possible to dynamically share the load as well as to respond rapidly to changes demanded by the load 116. Further, integration of the QQ system controller 110 within the various QQ pump systems 102 may be configured to respond quickly perturbations that affect the system response compared to the varying load demanded or desired. Further, the QQ system controller 110 may enable the ability to isolate cylinders or cylinder banks to provide high pressure at a selected (sometimes maximum) RPM allowed based on the available power. Moreover, the QQ system controller 110 may be configured to isolate cylinders or cylinder banks in response to sticking or failure or peak pressure in excess of a threshold pressure. Other implementations are also possible.

The motors 118 of the QQ pump system 102 may have the ability to observe and to mitigate cyclical or isolated variations in torque (torque ripple) caused by the motors 118 and the load of the power end 122 on a common shaft. In a particular example, the QQ system controller 110 may be distributed across the motors 118 of the QQ pump system and may be configured to selectively control portions of the motors 118 independent of other portions. In some implementations, each stator coil of a plurality of stator coils of each of the one or more motor 118 may be controlled independently of other stator coils.

In certain embodiments, the shaft 120 may be formed from composite materials. The shaft 120 of the power end 122 may be designed to be stiff, by means of geometry and material modulus, to minimize undesirable energy storage and harmonic phenomena. Such undesirable energy storage and harmonic phenomena may be further mitigated by mechanical and electronic means of damping, which may be integrated within the motors 118 and optionally within the fluid ends 124.

It should be appreciated that the embodiment of the system 100 provides a simplified view of a highly complex and integrated system, which may be configured to deliver more than 21,000 HHP from a single QQ pump system 102. Multiple QQ pump systems 102 may be combined in series and/or in parallel to provide a desired hydraulic horsepower. In some embodiments, the system 100 may be constructed in a single integrated unit or housing measuring approximately 108×160×72 inches and weighing less than 80,000 lbs. Other embodiments are also possible.

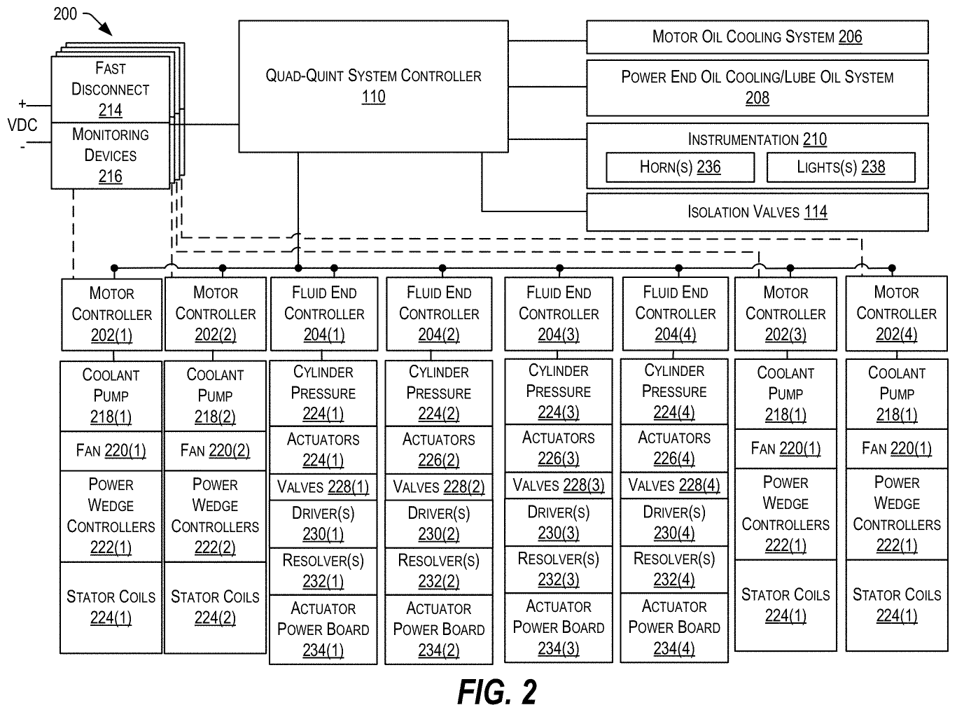

It should be appreciated that the QQ pump system 102 may include a plurality of actuators, sensors, and systems. One possible example of some of the components of the QQ pump system 102 is described below with respect to FIG. 2.

FIG. 2 depicts a block diagram of a system 200 including a QQ pump system 102, in accordance with certain embodiments of the present disclosure. It should be appreciated that the system 200 may include all of the elements of the system 100 of FIG. 1 and may include additional details to facilitate understanding.

The system 200 may include a QQ system controller 110 coupled to a plurality of motor controllers 202, a plurality of fluid-end controllers 204, a motor oil cooling system 206, a power end oil cooling/lube oil system 208, and instrumentation 210 (pressure, temperature, flow, vibration, and so on). The instrumentation 210 may include horns 236 and lights 238. Further, the QQ system controller 110 may be coupled to one or more isolation relief valves 114. The QQ system controller 110 may be coupled to a direct current voltage (VDC) source through a plurality of fast disconnect components 214, which may include or be coupled to monitoring devices 216 and associated circuitry that may be configured to detect and shunt transient power spikes to protect the QQ system controller 110. In this example, the QQ system controller 110 is being protected. In the context of the system as a whole, the motors 118 and the power electronics may be protected by the DC fast disconnect circuits 214. Such disconnect circuits 214 may also control stored energy discharge during emergency shut down or other fault management events, which may be initiated by the machine health management of the QQ system controller 110 or by other safety systems or priority interrupts.

In one possible implementation one or more electrical motors 118 may be coupled to one or more motor controllers 202. Each motor 118 may include a rotor and a stator. The rotor may be formed from a plurality of magnets. The stator may be comprised of a plurality of stator coils 224, which may be grouped (for control purposes) into power wedge controllers222. Each of the power wedge controllers 222 may be associated with one or more stator coils 224. Each power wedge controller may include power storage, sensors, and associated driver circuitry to drive each stator coil 224 independently of other coils 224, and so on.

The motor controller 202 may be coupled to a pump 218, a fan 220, the plurality of power wedge controllers 222 (one for each wedge or grouping of stator coils), and the plurality of stator coils 224. The pump 218 may be configured to circulate oil and/or other coolant through the motor 118 and through the stator coils 224 to maintain a desired operating temperature. The fan 220 may be configured to circulate air within the motor 118 to provide active cooling.

Each fluid end controller 204 may include a plurality of components. In an example, each fluid end controller 204 may include one or more cylinder pressure sensors 224, a plurality of actuators 226, and a plurality of valves 228. The fluid end controller 204 may be configured open valves to relieve pressure when the piston-plunger assembly pressure exceeds a predetermined threshold. Further, each fluid end controller 204 may include a plurality of driver circuits230, one or more resolver circuits 232 configured to measure degrees of rotation of the shaft 120, and an actuator power board 234 coupled to the H-bridge drivers 230, the actuators 226, and the valves 228. In some embodiments, the fluid-end controller 204 may control operation of the positive displacement push rods of a particular sliding slotted yokes of the pump, such as when one of the piston-plunger assemblies is disabled.

The direct drive motors 118 and the power end 122 require very little maintenance, especially compared to the number of large diesel engines, transmissions, reduction gears and conventional power ends replaced hereby. The fluid-ends, incorporated into the QQ system 200, may be relatively high maintenance and prone to failure due to erosion of valves when pumping a fluid slurry containing a high percentage of proppant material, commonly known as sand. The incipient failures can be observed by analyzing the cylinder pressure 224 and vibration in each cylinder bank via sensors incorporated within the motors 118 and the fluid ends 122. In order to mitigate the impact of an individual cylinder failure, the QQ system 200 may include two mechanisms to isolate a failing cylinder, as well as a means to isolate a cylinder bank: isolation and disconnection. It should be appreciated that isolation is distinct from disconnection. Disconnection refers to a state in which piston-plunger assembly motion is reduced or ceases entirely until the plunger is reconnected or “loaded”.

Isolation means that the low pressure inlet, the high pressure outlet, or both are isolated from the respective fluid conveyance manifolds. Isolation may also be achieved by allowing the piston chamber to return fluid to the low pressure supply manifold, without passing fluid to the high pressure manifold. This is sometimes referred to as freewheeling and may also occur with vapor of the low-pressure supply that is closed off by a valve.

In one embodiment, the disconnect mechanisms 130 may include a mechanical element, a hydraulic element, an electrical element, or an electromechanical component that may be controlled to isolate a selected push rod 128. The disconnect mechanism 130 may include a releasable coupling that can be disengaged to deactivate the push rod 128. In another embodiment, a gear or clutch or other mechanical feature may be controlled to mechanically disconnect the cylinder. In still another embodiment, a hydraulic or mechanical element may be incorporated that may be controlled to disconnect a single piston-plunger assembly 136 or a complete cylinder bank (a subset of piston-plunger assemblies 136) of the fluid ends 124, which may also utilize one of the hydraulic and the mechanical element in order to unload the power-end 124 (or a specific cylinder of the power end 124). Other embodiments are also possible.

In some embodiments, the power-end 124 may have the capacity to operate despite load imbalances that may result from isolating one or more cylinders or cylinder banks. Further, sufficient reserve capacity is available in the system 200 to maintain a selected pressure and flow rate by isolating one or more cylinders or cylinder banks and increasing the RPM of the power end or of the system 200. In some implementations, the ability to engage select push rods 128 could be utilized to create a graduated output ramp (gradual flow increase) that allows the motor 118 to operate more efficiently (RPMs versus torque, for example). In some implementations, the selective isolation of the fluid ends 124 and selective decoupling of the push rod 118 from the piston-plunger assembly 136 may provide failure mitigation, allowing for disabling of a piston-plunger assembly 136 that is impeded while allowing the power end 122 and remaining connected elements of the fluid end 124 to continue to operate.

The system 200 may include distributed processors to monitor, analyze, and act to maintain output in response to incipient or actual failures. This capability is referred to herein as “machine health management.” The QQ system controller 110 may be configured to send data to and receive data from the command and communications system 104, which may apply analytics to the data, to historical data, and to other operating parameters and which may provide a graphical interface through which an operator may view the analytics data. Trend analysis and reporting via the graphical interface may allow the user/operator to plan maintenance rather than incur total failure during a pumping operation. In some implementations, reducing demand on a component to prevent over temperature, mechanical or electrical stress, or other conditions, while increasing the contribution or response from other components is an example of machine health management, which can be managed by the QQ system controller 110. In some implementations, in addition to such adjustments, the QQ system controller 110 may generate an alert or may send signals to the command and communications system 104 to report the condition. In general, the condition is reported to allow preventive maintenance at a convenient opportunity, while extending the operating life of the affected components and maximizing the availability of the entire system. Observability of the component parameters enables the controllability, and the QQ system controller 110 provides the instructions for adjusting operation to prevent overload in order to maintain component life and reliability. These concepts are combined in distributed control of the system, on multiple levels.

The system 200 can continue to operate despite multiple partial failures, while informing the user/operator of its status, remaining capacity, and predicted service life. A multiplicity of QQ systems can be employed in a larger system, with capability between the QQ pump systems 102 to share the load as well as to respond rapidly to changes in the load demanded or to perturbations that affect the system response compared to the varying load demanded or desired.

In some embodiments, the motor controllers 202 and the fluid end controllers 204 may be configured to selectively activate or deactivate one or more components. The fluid-end controllers 204 may provide the ability to isolate one or more cylinders or cylinder banks to provide high pressure at the selected RPM (sometimes the maximum RPM allowed by the available power).

In some implementations, the motor controller 202 can observe and mitigate cyclical or isolated variations in torque (torque ripple) caused by the motors 118 and the load of the power end 124 on the shaft 120. The rotatable shaft 120 may be stiff, by means of geometry and material modulus, to minimize undesirable energy storage and harmonic phenomena, which is further mitigated by mechanical and electronic damping. Each of the motors 118 may include a multiplicity of power wedges, including power electronics and electromagnets, which may be individually controlled and cooled. The resulting observability and controllability can be utilized in the machine health management functions that are distributed among the controllers in each power wedge and each motor.

Voltages, currents, and temperatures can be measured at a multiplicity of locations, allowing individual limits to be honored, while sharing the load among the electromagnets, power wedges, and motors 118. Generally, the life of electronic components and insulation materials may be reduced by half for example by each 10 degrees Celsius of temperature rise above a rated temperature. By observing, controlling, and sharing the load, the life cycle of the QQ pump systems 104 may be extended and incipient failure may be predicted, but also mitigated, by reducing the load demanded of the comparatively hot components and by increasing the cooling.

Power management and fast response to sudden failure may mitigate damage. Further, the operation of the system 200 may be preserved by partially or completely disabling power wedges (subsets of the stator coils 224 or motors 118). In some embodiments, a low power, low stress mode of operation can be invoked prior to complete failure of a particular power wedge or motor by providing only the current required to counter the back electromagnetic force (EMF) and resulting torque seen by each electromagnet.

In some embodiments, performance may be enhanced by deterministic computation and control of the electromagnetic field of each stator coil 224. As each power wedge determines the rotational angle of the shaft 120 and the information is shared between multiple motor controllers 202, the position in electrical degrees can be determined precisely.

Further, in some embodiments, the control of the optimum waveform for each individual electromagnet can be optimized by the motor controller 202 for a given motor 118, depending on a mode or state set by the system. The motor controller 202 may be configured to adjust the waveform for one or more of the electromagnets for selected power or efficiency at any given combination of available supply power, load commanded or observed, and environmental factors, such as ambient temperature and various internal temperatures.

In some embodiments, very fast transient responses at exceptionally high instantaneous or short duration power levels can be attained within the limits of the components and the available inertial and convective cooling. It may be possible to ramp from zero RPM to more than 150 RPM at full load in a single revolution. It should be appreciated that the system may operate a selected RPM level. The variability in load scenarios allows for wide variation in the speed of operation. In some implementations, the system 200 may be configured to operate under conditions that call for extreme torque due to extreme pressure. If lower pressures are desired, the limits of moving components and the heat produced by the power electronics may change dramatically, allowing for other operating speeds. Further, in some embodiments, it may be possible to hold the motors 118 stationary, or to advance in very small increments, to facilitate pressure testing of the fluid delivery system.

In a particular embodiment, oil cooling can be managed by pumps 218 and fans 220. Expansion of oil due to temperature changes can be managed by means of bladders in expansion tanks. Oil quality in terms of particulates, dielectric strength, and moisture content can be observed and controlled by filtering in an oil quality subsystem that is part of the machine health management system. Filter differential pressures may be used to manage preventive maintenance. Separate reservoirs can be used to add, maintain, and clean or polish oil being added to or removed from the circulating system, preventing ambient temperature changes from introducing moisture and contaminates to the oil. A separate system (e.g., motor oil cooling system 206) can be used to manage the cooling oil for the power end 122 from the cooling oil for the electric motors 118, although they may use the same type of oil.

It should be appreciated that the distributed control of the QQ system controller 110 may allow certain peak performance for a short time. In some instances, the distributed control may allow for isolation of a portion of the system for cleaning or cooling during ongoing operations. External connections may be made and utilized by the operator or the machine health management system of the QQ system controller 110, if cleaner or cooler fluid is made available, for example. Reserve capacity information then allows the QQ system controller 110 to achieve higher levels of performance under challenging operating conditions, while preserving the life of the system.

The QQ system controller 110 may communicate with the control system 100 and with various components using Ethernet connections, CAN connections, local wiring connections, or any combination thereof. Further, the QQ system controller 110 may include program memory configured to enable control of the motor controllers 202 and fluid ends 204, including security, encryption, and interrupt management.

The system 200 may include power link control using the fast disconnects 214 and the monitoring devices 216. In an example, the power link control may be provided by the QQ system controller 110, the monitoring devices 216, or both. In an example, the monitoring devices 216 may monitor the voltage and current and may detect transient spikes. The monitoring devices 216 or the QQ system controller 110 may activate the fast disconnect 214 in response to detecting the transients in excess of a predetermined threshold. Further, the system 200 may include an electrical stop using an external disconnect, internal fast disconnects 214, local bypass or disconnect circuitry, and actuation (e.g., lights 212, horns 238, isolation valves 114, other components, or any combination thereof).

In some embodiments, the system 200 may include low pressure and high pressure manifolds including instrumentation 210. The low pressure fluid manifold may include pressure, temperature, flow, and vibration sensors or instrumentation 210, which may be provide signals to the QQ system controller 110. The QQ system controller 110 may be configured to provide a fast Fourier transform (FFT) or other type of analysis to the plurality of sensor signals to determine feedback information, which may be used to adjust one or more of the motor controllers 202 and the fluid ends 204. Further, the high pressure manifold may include pressure, temperature, flow, and vibration sensors or instrumentation 210, which may be provide signals to the QQ system controller 110. The QQ system controller 110 may be configured to provide a fast Fourier transform (FFT) or other type of analysis to the plurality of sensor signals to determine feedback information, which may be used to adjust one or more of the motor controllers 202 and the fluid end controllers 204.

In operation, the QQ system controller 110 may determine information related to initial conditions and the state of the system. Further, the QQ system controller 110 may be configured to maintain a calibration table for adjusting the various elements (motor controller 202 and associated components, fluid end controllers 204 and associated components, and optionally other elements). The QQ system controller 110 may be configured to log data in memory using circular buffers and optionally a non-volatile memory configured to store historical data. Further, the QQ system controller 110 may include analytics, such as a machine health interpreter/manager, configured to determine limits, provide exception reporting, perform trend analysis, provide redundancy, and provide compensation and load balancing. The QQ system controller 110 may also include a command dictionary defining a plurality of commands, a data dictionary defining parameters of the system, a state dictionary defining various states of the system, communication protocols, and self-test/calibration tools.

In some embodiments, the QQ system controller 110 may include an external interface and communications connection to a larger fracking system. Further, the QQ system controller 110 may include a plurality of input/output interfaces configured to couple to a plurality of controllers, monitors, sensors, and actuators. The QQ system controller 110 may include interfaces and connections to diagnostics as well as local power status and control instrumentation, micro-controllers, and actuators.

The motor controller 202 may include a motor oil condition monitor, configured to operate in conjunction with pumps 218 and fans 220 controlled by each motor controller 202. The motor oil condition monitor may be configured to determine oil levels, motor temperatures, dielectric parameters, moisture levels, particle levels, filter differential pressures, and so on. Further, the motor oil condition monitor may be configured to monitor oil circulation valves to connect central/fill reservoir bladders for each motor 118 (if applicable), to control pump cleaning, and to control relief vents and bleed valves, which may include an indicator.

The fluid end controllers 204 may include a pump oil condition monitor, which may be configured to determine oil levels, pump temperatures, dielectric parameters, moisture levels, particle levels, filter differential pressures, and so on. Further, the pump oil condition monitor may be configured to monitor valves to connect central/fill reservoir bladders for each power end 122 (if applicable), to control pump cleaning, and to control relief vents and bleed valves, which may include an indicator. The fluid end controllers 204 may be configured to selectively actuate one or more disconnect mechanisms to decouple the piston rod 128 from the piston-plunger 136 of the fluid end 124. Further, in some implementations, the fluid end controllers 204 may be configured to receive signals from a plurality of sensors and to perform a fast Fourier transform (FFT) analysis of the signals to determine health and status of each cylinder of the fluid end 124.

In some embodiments, the fluid end controllers 204 may include input/output interfaces to cylinder pressure sensors, accelerometers, temperature sensors, pressure sensors, and analytics circuitry (configured to determine cylinder, fluid end analysis, and management). Further, the fluid end controllers 204 may include various actuators 226 (such as mechanical disconnect actuators, mechanical reconnect actuators, fluid bypass actuators, and high pressure fluid end isolator valve actuators), low pressure fluid end isolator valve actuators, driver circuits 230, resolvers 232, and actuator power boards 234.

The motor controllers 202 may include interfaces to cooling pumps 218, cooling fans 220, accelerometers, temperature sensors, pressure sensors, and management circuitry (such as cylinder, fluid end analysis, and management circuitry). The motor controllers 202 may include a plurality of power wedges, which may have two controllers. The motor controllers 202 may include power management including a DC link voltage connector and management, a DC link current connector and management, and a voltage controller. Further, the motor controllers 202 may include fault management circuitry, a processor configured to selectively adjust one or more parameters, and a harmonic analyzer to determine harmonics of the system. Other embodiments are also possible.

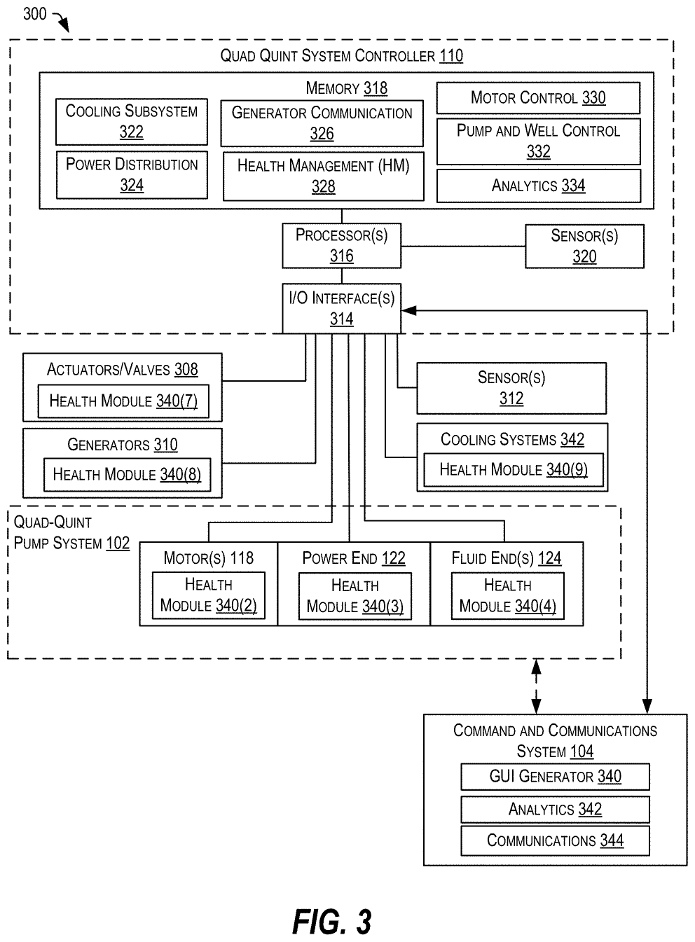

It should be appreciated that the QQ system controller 110 may be distributed across a plurality of components or may integrated (in total) within each of a plurality of components of the system 200. One possible implementation of a QQ system controller 110 is described below with respect to FIG. 3.

FIG. 3 depicts a block diagram of a system 300 including the QQ pump system 102 including components of a control system, in accordance with certain embodiments of the present disclosure. The QQ system controller 110 may be distributed across multiple components of the QQ pump system 110. While the QQ system controller 110 is depicted as being separate from the QQ pump system 102. It should be appreciated that the QQ system controller 110 may be integrated within the QQ pump system 102 and may be distributed across multiple components. For example, the QQ system controller 110 may include distributed control circuits, which may reside in the stator assemblies of one or more electric motors 118 and which may be associated with subsets of the stator coils 224. Further the QQ system controller 110 may include health management modules 340, which may be distributed within the motors 118 and the power end 122 and which may interact with each other, with sensors, with other devices, with other systems, or any combination thereof.

The system 300 may include one or more QQ system controllers 110 coupled to the QQ pump system 102, which may include one or more power ends 122 and one or more motors 118. In the illustrated implementation, the QQ pump system 102 may include pair of electric motors 118(1) and 118(2) coupled to one end of a shaft 120 and may include a second pair of electric motors 118(3) and 118(4) coupled to the other end of the shaft 120. The motors 306(1) and 306(2) may cause the shaft to rotate. The power end 122 may be driven by the rotation of the shaft 120.

The QQ system controller 110 may also be coupled to one or more actuators/valves 308, one or more generators 310, 342one or more sensors 312, and one or more cooling systems 342. The QQ system controller 110, the actuators/valves 308, the one or more cooling systems 342342, and the one or more sensors 312 may be stand-alone devices or may be integrated within the QQ pump system 102, depending on the implementation.

The QQ system controller 110 may include one or more input/output (I/O) interfaces 314, which may be configured to communicate with the actuators/valves 308, the one or more generators 310, the one or more cooling systems 342, the one or more sensors 312, the motors 306, and the power end 122. In some embodiments, the I/O interface 314 may include an Ethernet connection, a universal serial bus (USB) connection, a controller area network (CAN) connection, a wireless (radio frequency) communications interface, another type of communications interface, or any combination thereof. In some embodiments, the I/O interface 314 may also communicate with (send data to and receive data, including commands, instructions, and data from) the command and communications system 104.

The QQ system controller 110 may one or more processors 316 coupled to the I/O interface 314. The processors 316 may also be coupled to a memory 318 and to one or more sensors 336. The memory 318 may be configured to store data and to store instructions that, when executed, may cause the one or more processors 316 to manage operation of the QQ pump system 102.

The memory 318 may include cooling subsystem instructions 322 that, when executed, may cause the one or more processors 316 to send signals to a cooling subsystem (coolant pumps 218, coolant fans 220, and so on) of the QQ pump system 102. In some implementations, the cooling subsystem instructions 322 of the QQ pump system 102 may control multiple cooling subsystems, which may be distributed throughout the motors 118, the power end 124, and the various components. In some implementations, the cooling subsystem controller 110 may be configured to control the cooling subsystem of a particular motor controller 202, for example, to control operation of pumps and fans (such as pumps 218 and fans 220 in FIG. 2).

The memory 318 may include power distribution instructions 324 that, when executed, may cause the one or more processors 316 to sends signals to power interface circuitry, such as fast disconnect circuitry 214 and monitoring devices 216 in FIG. 2. Further, the power distribution instructions 324 may cause the processors 316 to send control signals to one or more of the power wedges within the stator assembly to independently control the signal to each of the stator coils 224.

The memory 318 may also include generator communication instructions that, when executed, may cause the one or more processors 316 to send signals to one or more generators 310, which may be field generators configured to power the system. For example, the QQ system controller 110 may be configured to determine its current power demands and optionally to anticipate power demands based on received command signals, load sensing, and machine health considerations. The QQ system controller 110 may anticipate future power demands and send a notification to the generators, which allows the generators output to respond very quickly by varying the field excitation, drawing on the reserve of rotational energy in the turbine and generator. Other implementations and integrations are also possible.

The memory 318 may further include motor instructions that, when executed, cause the one or more processors 316 to send signals to the motor controllers 202 in FIG. 2. The memory 318 may also include pump and well control instructions 332 that, when executed, may cause the one or more processors 316 to send signals to fluid ends 204 in FIG. 2. Further, the memory 318 may include analytics 334 that, when executed, may cause the one or more processors 316 to process data from the sensors 338, the sensors 312, the actuators/valves 308, and the cooling systems 342, and to generate control signals within the limits of available power from the generators 310 to selectively adjust operating parameters.

The system 300 may further include the command and communications system 104. The command and communications system 104 may include a computing device including a processor and a memory, which may store data and instructions that may be accessible to the processor.

In some implementations, the command and control system 104 may include one or more input interfaces (such as a keyboard, a mouse or other pointer, a track pad, other input components, or any combination thereof). The command and control system 104 may further include one or more output interfaces (such as a display, a printer, other output devices, or any combination thereof). The command and communications system 104 may further include one or more communication interfaces, which may include wireless transceivers, one or more universal serial bus (USB) devices, one or more other interfaces, or any combination thereof.

The command and communications system 104 may include graphical user interface (GUI) instructions 340 that may cause the processor to generate a graphical interface accessible by a user or operator to review data and optionally to provide control signals that may be configured to control one or more parameters of the QQ pump system 102.

The command and communications system 104 may further include analytics instructions 342 that, when executed, may cause the processor to analyze data received from the one or more sensors, the generator, and the operating state of the QQ pump system 102. The analytics instructions 342 may cause the processor to determine adjustments to operating parameters for the QQ pump system 102. Other embodiments are also possible.

The command and communications system 104 may also include communications instructions 344 that, when executed, may cause the processor to generate alerts or reports based on the analytics, based on sensed data, or based on other parameters or elements. In one possible example, the analytics 342 may cause the processor to determine early indications of failure or fault conditions, and to generate an alert that may warn an operator/user. The alert may be presented within a graphical interface or may be sent as a text message, an email, a voice alert, an alarm, a visual indicator, or any combination thereof. Other embodiments are also possible.

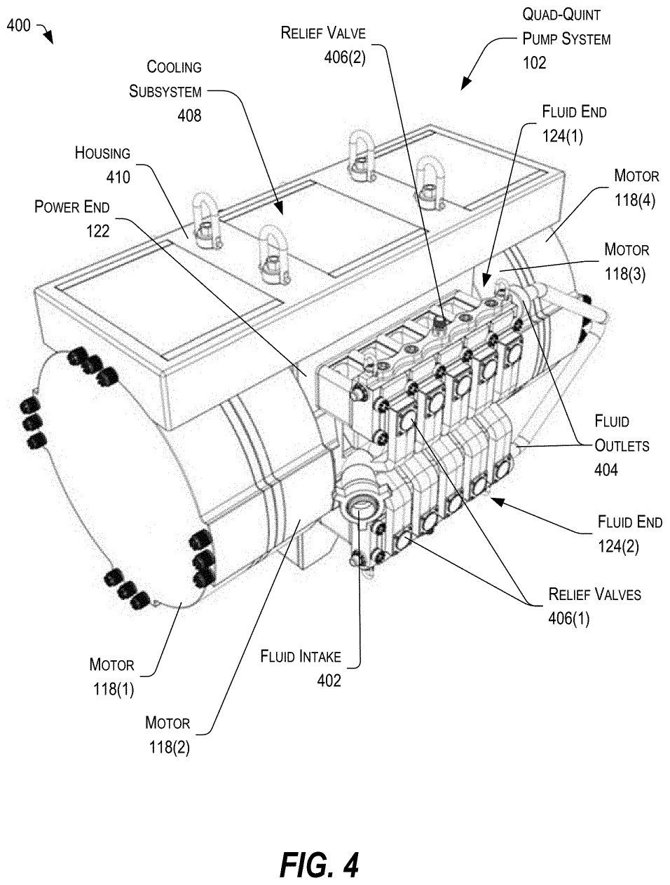

FIG. 4 depicts a perspective view 400 of a QQ pump system 102, in accordance with certain embodiments of the present disclosure. The QQ pump system 102 may include the power end 122 coupled to a bank of fluid ends 124. In this example, a second bank of fluid ends 124 may be coupled to the other side of the power end 122. The QQ pump system 102 may include one or more fluid intakes 402 coupled to a fluid source (such as the fluid system 112 in FIG. 1) to receive low pressure, high volume fluid flow. The QQ pump system 102 may include one or more fluid outlets 404, which may be coupled to a bore hole or well to provide high pressure fluid downhole, for example. The QQ pump system 102 may be an embodiment of the pumps described in co-pending U.S. patent application Ser. No. 16/373,583 filed on Apr. 2, 2019 and entitled “Pump Apparatus with Reduced Vibration and Distributed Loading”, which is incorporated herein by reference in its entirety.

The motors 118 may be arranged in multiples on either end of the power end 122. In this example, motors 118(1) and 118(2) may be arranged as a pair and which may be coupled to one end of the shaft 120. The motors 118(3) and 118(4) may also be arranged in a pair and may be coupled to the other end of the shaft 120. The power end 122 may include a plurality of yoke frames (yoke frames 502 in FIG. 5) that may be arranged along the shaft 120 in the space between the pairs of motors 118. The yoke frames may engage the shaft 120 via an eccentric coupled to the shaft 122, which may cause the yoke frames to transfer the rotational motion of the shaft 120 to linear motion of the yoke frames along a path that is perpendicular to the axis of the shaft 120, causing the piston-plunger assemblies 136 to push fluid from the fluid intake 402 through the fluid ends 124 to the fluid outlets 404.

The QQ pump system 102 may further include a cooling subsystem 408 that extends over the motors 118 and the power end 122 within the top portion of a housing 410. The cooling subsystem 408 may be configured to interface with one or more components of the motors 118 and the power end 122 to deliver coolant oil (via pumps 218), liquid coolant (sometimes in the form of mist, which may be pushed through spray nozzles by another of the pumps 218), moving air (from fans 220) or any combination thereof.

FIG. 5A depicts a diagram of a pump apparatus 500, in accordance with certain embodiments of the present disclosure. The apparatus 500 may include a yoke frame 502 coupled to or integrated with a plurality of push rods 128. It should be understood that the push rods 128 may be coupled to a piston-plunger assembly 136 of the fluid end 124. In some implementations, the push rod 128 may be replaced with a piston-plunger assembly.

In response to rotation of a rotating shaft 120, the yoke frame 502 may move back and forth as indicated by arrow 506. The yoke frame 502 may have a substantially square shape and may include an opening 510 sized to receive a bushing 508, which may fit within and which may be smaller than the opening 510. The bushing 508 may include an opening sized to receive an eccentric 512 and bearings 514. The eccentric 512 may include an opening sized to receive the shaft 120.

The shaft 120 may rotate as indicated by the arrow 518. In this example, the arrow 518 indicates a counterclockwise rotation, but other rotations are also possible. Rotation of the shaft 120 causes the eccentric 512 to rotate as indicated by the arrow 520. As the eccentric 512 rotates about a longitudinal axis of the shaft 120, the eccentric 512 moves the bushing 508 up and down within the opening 510, as indicated by the arrow 522, and also moves the bushing 508 side to side pushing the yoke frame 502 back and forth in the direction indicated by the arrow 506. It should be appreciated that rotation of the eccentric 512 causes the bushing 508 to move in both the direction of arrow 522 and the direction of arrow 506, pushing the yoke frame 502 back and forth. In some implementations, the interior surface of the opening 510 may include a low-friction coating 534 (or layer) to facilitate movement along the interface between the bushing 508 and the yoke frame 502.

In the illustrated example, rotation of the shaft 120 causes the eccentric 512 to rotate about the shaft 120, causing the bushing 508 to move and pushing the yoke frame 502 back and forth. The structure of the eccentric 512, the bearings 514, the bushing 508, and the opening 510 cooperate to translate rotational movement of the shaft 120 into linear movements of the bushing 508 and the yoke frame 502. As the yoke frame 502 moves back and forth, the push rods 128 may push into and pull out of cylinders to drive fluid out of the cylinder and to draw fluid into the cylinder.

It should be appreciated that the illustrated example of the yoke frame 502 includes four push rods 128, each of which may correspond to a piston-plunger 136 to drive fluid or draw fluid in tandem within four fluid ends 124. When the yoke frame 502 moves in a first direction (e.g., to the right in the drawing), the push rods 128 along that edge may cooperate with a piston-plunger 136 within the fluid ends 124 to drive fluid from a fluid chamber to a fluid outlet 404, while the push rods 128 on the opposing edge may cooperate with plungers 136 within the fluid ends 124 to draw fluid from an inlet 402 into their respective fluid chambers. As the yoke frame 502 moves in the other direction (e.g., to the left in the drawing), the push rods 128 on that side may cooperate with plungers 136 to drive fluid out of their respective chambers, while the push rods 128 on the other side cooperate with plungers 136 to draw fluid into their respective chambers. This structure allows each yoke frame 502 to drive fluid during a first half of a rotational period of the shaft 120 and to draw fluid during a second half of the rotational period.

In some implementations, the yoke frame 502, the push rods 128, the bushing 508, and the eccentric 512 may be made of composite materials. Such materials can include carbon fiber, Teflon, Kevlar, other materials, or any combination thereof. The material selection allows the QQ pump system 102 to be significantly lighter than traditional pump devices, which makes the QQ pump system 102 easier to transport. Moreover, the composite materials may be stronger and more wear resistant than traditional pump materials. Other advantages may also be possible.

FIG. 1B depicts a cross-sectional view 530 of the pump apparatus of FIG. 5A, taken along line B-B in FIG. 5A. This view 530 further includes a cover 532 and a guide 536, which are not shown in FIG. 5A, but which are shown here for discussion purposes. The view 530 includes the yoke frame 502, the bushing 508, the bearings 514, the eccentric 512, the shaft 120, and the opening 510. The apparatus may include a cover 532, which may be coupled to either side of the yoke frame 502. The cover 532 may be made from a composite material, which may be the same composite material as that used to form the yoke frame 502. The cover 532 may operate as a guide to restrain movement of the bushing 508 within a plane parallel to the cover 532. Additionally, the cover 532 may serve to ensure the rigidity of the slotted yoke frame during very high loads. Further, the yoke frame 502 may fit into a guide 536 on either end. The guide 536 may be part of a crank housing or may be in addition to a crank housing and may be configured restrain lateral movement of the yoke frame 502 to allow movement of the yoke frame 502 in the direction indicated by arrow 506.

FIG. 5C depicts a perspective view 540 of the apparatus of FIG. 5A including a cover 532, in accordance with certain embodiments of the present disclosure. In this example, the cover 532 includes an opening 534 sized to fit over the shaft 120 and to allow the yoke frame 502 to move back and forth with rotation of the shaft 120.

In this example, the edges of the yoke frame 502 include openings or connectors 538 to connect a push rod 128 to the yoke frame 502. In this example, each connector 538 may include a threaded opening sized to receive and configured to secure a push rod 128. Other implementations and other types of connectors are also possible. In certain embodiments, the push rod 128 may be integral to the yoke frame 502 and may include features to facilitate coupling to the plungers 136 of the fluid ends 124, with superior seal life.

It should be appreciated that the apparatus depicted and described in FIGS. 5A-5C is a yoke frame assembly that be one of a plurality of such assemblies coupled to a single shaft 120 to form a power end 122. In one possible implementation, one or more QQ pump systems 102 (each of which may include a plurality of yoke frames 502) may be arranged on the back of a truck. Each QQ pump system 102 may be configured to fit on the width of a truck or trailer with the rotating shaft 120 extending parallel to the driveshaft of the truck. Thus, the QQ pump system 102 may be mobile and may be driven to a drill site and connected between a fluid source and a conduit to drive fluid, such as mud, into the conduit. Polyphase fluids, sometimes containing solids, liquids, and gases may be pumped by the QQ pump systems 102. Sizes of push rods 128 and corresponding sizes of the piston-plunger assemblies 136 could be varied to allow compression of gases to a high pressure to mix with a fluid that is less compressible in other cylinders of the QQ pump systems 102. Selectively engaging additional pistons could allow variation in the mixture of gas and liquid.

In some embodiments, multiple QQ pump systems 102 may be configured to drive fluid under high pressure and high volume. In one possible example, a plurality of QQ pump systems 102 may be driven by a common drive shaft. Other implementations are also possible.

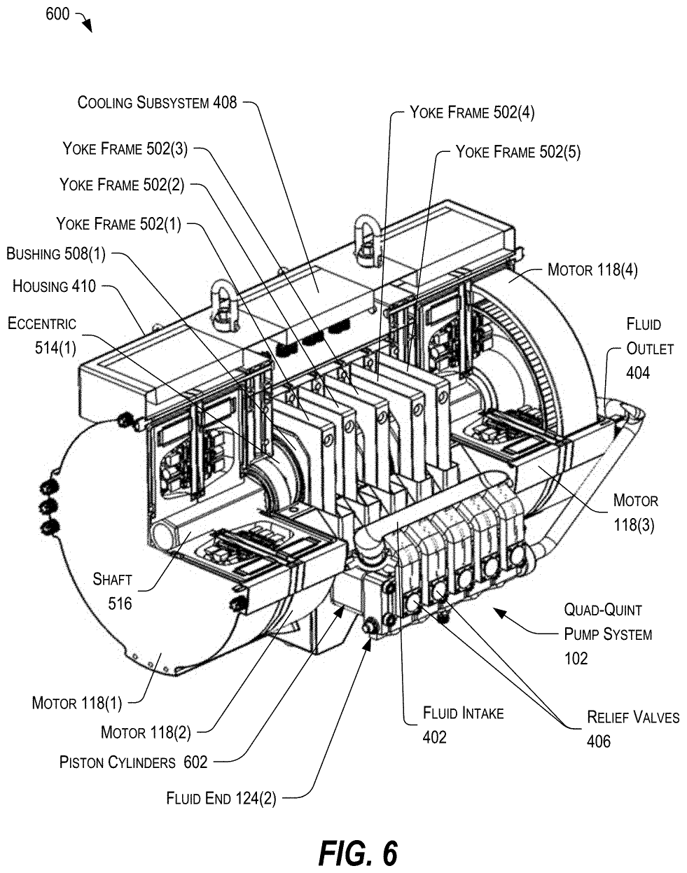

FIG. 6 depicts a perspective view 600 of the QQ pump system 102 of FIGS. 1-5 with a portion of the cover removed to show the yoke frames 502 in situ, in accordance with certain embodiments of the present disclosure. In this example, a portion of the housing 410 is removed to make the inner components of the QQ pump systems 102 visible. The QQ pump systems 102 may include five yoke frames 502 arranged along the shaft 120. Each of the yoke frames 510 may be configured to slide back and forth in a direction that is perpendicular to the axis of the shaft 120 with rotation of the shaft 120. Each of the yoke frames 502 may include four piston-plunger assemblies 136 or fluid ends 124 (two on a first side and two on a second side opposite to the first side). Further, the pump 102 may include a fluid intake 402 coupled to each of the piston cylinders 612 to deliver fluid for pumping, and may include a fluid outlet 404 coupled to each of the piston cylinders 602 to receive pressurized fluid. The fluid may be a liquid, a gas, a composition (such as drilling mud), other flowable material, or any combination thereof.

The pump 102 may include a plurality of eccentrics 514, each of which may be associated with one of the yoke frames 502. Further, the QQ pump system 102 may include a plurality of bushings 508, each of which may be associated with one of the yoke frames 502. For example, the yoke frame 502(1) may include an opening 510(1) to receive a bushing 508(1), which is coupled to a corresponding eccentric 506(1). The slotted yoke frame 502(2) may include an opening 510(2) to receive a bushing 508(2). The bushing 508(2) may be coupled to a corresponding eccentric 506(2). The slotted yoke frame 502(3) may include a an opening 510(3) to receive a bushing 508(3), which may be coupled to a corresponding eccentric 506(3). The slotted yoke frame 502(4) may include an opening 510(4) sized to receive a bushing 508(4), which may be coupled to a corresponding eccentric 506(4). The slotted yoke frame 502(5) may include a bushing 508(5), which may be coupled to a corresponding eccentric 514(5). The eccentrics 508(1)-508(5) may be arranged at different orientations around the polygon-shaped shaft 120, such that each of the slotted yoke frames 502(1)-502E are at different positions (phases) of the pump cycle, distributing the load on the shaft 120 across the entire three hundred and sixty degree rotation of the shaft 120 (i.e., across a pump cycle).

While the embodiments described above with respect to FIGS. 1-6 include fluid ends 124 coupled directly to the yoke frame 502 (power end 122), in some embodiments, movement of the yoke frame 502 may cause the piston-plunger assemblies 136 to be actuated. In certain embodiments, a variety of methods may be used to mount and attach a piston-plunger 136 to the push rod 128 of the slotted yoke frame 502 or may be used to actuate the push rod 128 and piston-plunger assemblies 136 in response to movement of the yoke frame 502.

In certain embodiments, various structures and methods may be used to restrain the yoke frame 502 to the bushing 508. In certain embodiments, the yoke frame 502 can be restricted by structure provided within the housing 410 of the QQ pump system 102, such as bearing elements, the housing frame, or both. The bearing elements may provide a guided, low friction path allowing movement of the slotted yoke frame 502 in the direction of the fluid ends 124 and allowing movement of the bushing 508 within the slot or opening 510 of the yoke frame 502. Various different bearing elements may be used to achieve this low friction path, such as low-friction bearing pads (e.g., Teflon®, Nylon®, diamond-like carbon (DLC) or another low-friction material), rollers, wheels, reduced surface sliding steel on steel, and so on, with or without wings to control movement in a direction corresponding to an axis of the shaft 120. In some embodiments, including but not limited to those constructed of composite materials, certain surface treatments may be incorporated to reduce friction, to increase hardness, to introduce other properties, or any combination thereof. In some implementations, a compliance mechanism may be included within the slot of the yoke frame 502 to ensure continuous contact as the direction of the yoke frame 502 reverses and to adjust for ware over time.

It should be appreciated that the yoke frames 502 may be coupled to the shaft 120 such that the relative position within the cycle of the rotation of the shaft 120 places each yoke frame 502 in the power end 122 at a different stage of its loading cycle, thereby reducing overall vibration and distributing the load stresses across the entire rotation of the shaft 120. It should be appreciated that the push rods 128 have a linear path situated in the load path of the yoke frame 502. This structural configuration mitigates many of the failures seen in common power end assemblies that utilize a shaft 120 to drive the power end 122. In an example, as conventional pins begin to fail, the piston-plunger assemblies 136 may wobble, introducing wear. In contrast, the push rods 128 are in the force path of the yoke frame 502, reducing or eliminating wobble due to wear. Other advantages may also be realized from such a configuration.

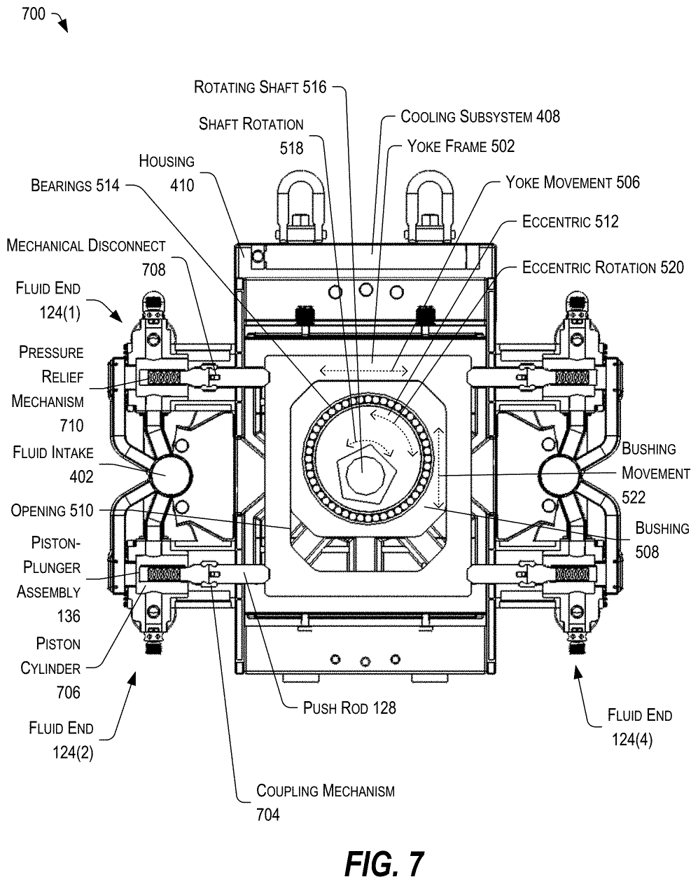

FIG. 7 depicts a cross-sectional view 700 showing a portion of the QQ pump system 102, in accordance with certain embodiments of the present disclosure. The portion view 700 includes a housing 410, which may be formed from a selected composite material, as discussed above. The housing 410 may define an enclosure. The QQ pump system 102 may further include a shaft 120, which may be supported by bearings at locations within the housing 410 between the yoke frames 502 so that it can only rotate about its longitudinal axis. In the illustrated example, the shaft 120 may have five sides, forming a pentagonal shape extending longitudinally along the shaft 120.

The QQ pump system 102 may further include an eccentric 512 including a pentagon-shaped opening sized to receive and engage the shaft 120. The pentagon-shaped opening in the eccentric 512 may be offset from a center of the eccentric 512 such that the center of mass of the eccentric 512 revolves around the shaft 120. The shape of the shaft 120 makes it possible, during manufacture, to arrange each of the eccentrics 512 in one of five orientations about the axis of the shaft 120.

The QQ pump system 102 may also include a bushing 508 sized to fit within the opening 510 of a slotted yoke frame 502. The interior surface of the opening 510 may include a low-friction coating selected to provide a sliding interface between the bushing 508 and the slotted yoke frame 502. The bushing 508 may include an opening sized to receive bearings 514 and to fit the eccentric 512, which may be configured to rotate about the shaft 120, turning the eccentric 512 and moving the bushing 508 and the frame 502.

The yoke frame 502 may have a substantially rectangular shape including two sides configured to slide back and forth within the housing 410 against a bearing surface or guide 136 and two sides that are each coupled to one or more push rods 128. Each push rod 128 may be coupled to a piston-plunger 136 by a coupling mechanism 704. The push rod 128, the piston-plunger 136, and the coupling mechanism 704 may be configured to operate as a piston-plunger assembly to draw fluid into a piston chamber or cylinder 706 from a fluid intake 402 and to push the fluid through a fluid outlet 404 at a selected pressure and volume. The push rods 128 may be actuated to move into and out of the piston cylinders 706 in response to transverse movement of the yoke frame 502. Movement of the yoke frame 502 may be restrained by bearing elements that facilitate movement of the slotted yoke frame 502 in a direction that is perpendicular to the longitudinal axis of the shaft 120. The bearing elements may also reduce wear.

In the illustrated example, the eccentric 512 may contact the bushing 508 via bearings 514 configured to facilitate rotational movement of the eccentric 512 relative to the bushing 508. Additionally, the bushing 508 may contact an interior surface of the opening 510 of the slotted yoke frame 502. The opening 510 may include a bearing surface, which may facilitate movement of the bushing 508 relative to the interior surface of the opening 510 of the slotted yoke frame 502. In a particular example, the interior surface of the opening 510 may be larger than the bushing 508 in at least one dimension, providing for excess space. The space may be configured to house or secure a compliance mechanism, sensors, and other elements.

Further, the exterior surface of the slotted yoke frame 502 may engage a slot or guide 536 of the housing 410, which may include an adjustable bearing surface to facilitate movement of the slotted yoke frame 502 relative to the housing 410. It should be appreciated that the bearing surfaces may include sliding bearings or other components to facilitate movement. In certain embodiments, the interior surface of the opening 510 and the guide 536 may include bearings on the sides in contact with the slotted yoke frame 502.

In some embodiments, the shaft 120 may rotate about its longitudinal axis, which remains constant relative to the housing 410. An opening in each eccentric 512 is offset from a center of the eccentric 512, and the rotation of the shaft 120 may cause a center of mass of the eccentric 512 to rotate about the axis of the shaft 120, pushing the bushing 508 within the opening or slot 510 of the yoke frame 502 and causing the bushing 508 to slide back and forth within the opening 510 and to push the yoke frame 502 back and forth.

It should be appreciated that the piston-plunger 136 may include a pressure relief mechanism 710. In one possible implementation, the pressure relief mechanism 710 may include one or more Belleville washers or coned-disc springs configured to dampen vibrations, impacts, or shock loads. Further, it should be appreciated that both sides of the yoke frame 502 may be configured to pump the fluid. In a particular example, the plungers 136 on the right side in the drawing may push fluid, while the plungers 136 on the other side draw fluid into a piston chamber or cylinder 706 by presenting a negative pressure. In some implementations, if the low pressure fluid is received from a feed pump, it could provide a slight positive pressure. As the slotted yoke frame 502 slides toward the left side in the drawing, the plungers 136 on the left side may push the fluid, while the plungers 136 on the right side draw fluid into their respective piston chambers 706. Thus, the slotted yoke frame 502 performs work in both directions (in other words, the yoke frame 502 drives fluid twice per rotation of the shaft 120).

Additionally, it should be appreciated that, in a QQ pump system 102 having five yolk frames 502 coupled to the shaft 120, the eccentric 512 associated with each of the yolk frames 502 can be oriented in one of five orientations about the shaft 120 (according to the pentagonal shape of the shaft 120), such that each of the yolk frames 502 may be at a different stage within the shaft's rotational cycle relative to the other yoke frames 502. This distribution of the yolk frames 502 across the pump cycle distributes the loading on the shaft 120, reducing peak loading stresses.

In certain embodiments, the opening 510 in the yoke frame 502 extends perpendicular to the desired direction of movement of the yoke frame 502 and the push rod 128 indicated by the arrow 606. The opening 510 in the slotted yoke frame 502 includes excess space in the direction that slotted yoke frame 502 is restrained (i.e., on the ends of the opening 510 closest to the bearing elements of the guide 536). The excess space may be used to insert a compliance mechanism when the bushing 508 is in a top or bottom position. Further, the opening 510 is tight to the bushing 508 in the direction that the piston-plunger assemblies 136 move (i.e., in the direction indicated by the arrow 506). The compliance mechanisms may be installed within the excess space or within an interior portion of the yoke frame 502 so as to not weaken the yoke frame 502.

In operation, rotation of the shaft 120 with the coupled eccentric 512 produces a rotational motion of the bushing 508, which moves inside the opening 510 of the slotted yoke frame 502. The bushing 508 is free to move within the opening 510 of the slotted yoke frame 502 in a first direction indicated by arrow 106, which first direction is perpendicular to the direction of push rod 128 movement (i.e., both directions indicated by arrow 506) due to the excess spaces at either end of the opening 510. When the movement of the bushing 508 is parallel to the push rod 128 movement (i.e., in both directions indicated by arrow 506), the slotted yoke frame 502 directly translates the rotational movement of the shaft 120 and the linear movements of the bushing 508 into linear movement of the yoke frame 502 due to the tight fit between the bushing 508 and the opening 510 of the slotted yoke frame 502 in this direction. The relative geometries of the shaft 120, the eccentric 512, the bushing 508, and the yoke frame 502 produce a sinusoidal slow movement at the piston end of a stroke when valves are opening and closing, and a fast movement in mid-stroke. This sinusoidal geometric operation provides an advantage for smooth machine operation and provides time for the valves to seat at relatively low speed.

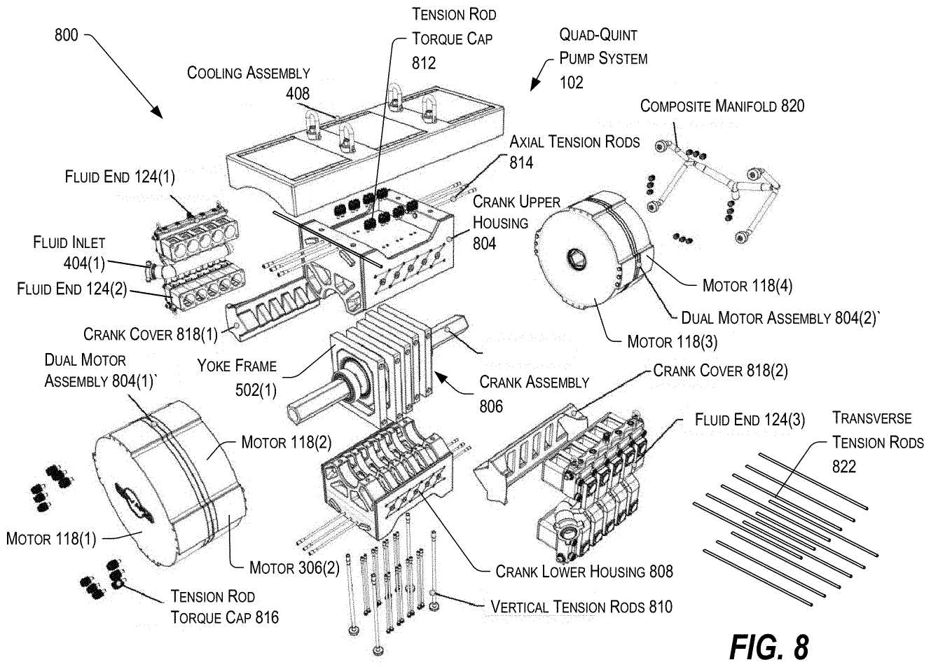

FIG. 8 depicts an exploded view 800 of components of the QQ pump system 102, in accordance with certain embodiments of the present disclosure. The view 800 includes two dual motor assemblies 804(1) and 804(1). The dual motor assembly 804(1) includes a first motor 118(1) and a second motor 118(2). Further, the dual motor assembly 804(2) includes a third motor 118(3) and a fourth motor 118(4). The dual motor assemblies 804(1) and 804(2) may be coupled to opposing ends of the shaft 120, which extends through a plurality of yoke frames 502 to form a crank assembly 806. The crank assembly 806 may fit within a housing clamshell that includes a crank upper housing 802 and a crank lower housing 808.

Vertical tension rods 810 may extend through the crank lower housing 808 and the crank upper housing 802 and may be fixed by tension rod torque caps 812. Further, transverse tension rods 822 may extend through the fluid ends 124(1) and 124(2) and through crank covers 818(1) and 818(2) and may be fixed by tension rod torque caps (not shown). Axial tension rods 814 may extend through the crank upper housing 802 and through the crank lower housing 808, through frames of the dual motor assemblies 804(1) and 804(2) and to composite manifold 820 on one end and to tension rod torque caps 816 on the other end. It should be appreciated that the tension rods secure the components and distribute loading from outside-to-outside of the device components. For example, loading on the fluid ends 124(1) due to the yoke frame 502(1) in one direction imparts a compression load on the fluid end 124(2), and so on.

The cooling assembly 408 may be mounted to the crank upper housing 802. The cooling assembly 408 may circulate cooling oil, direct air flow, and otherwise mitigate heating of the components of the QQ pump system 102. Other implementations are also possible.

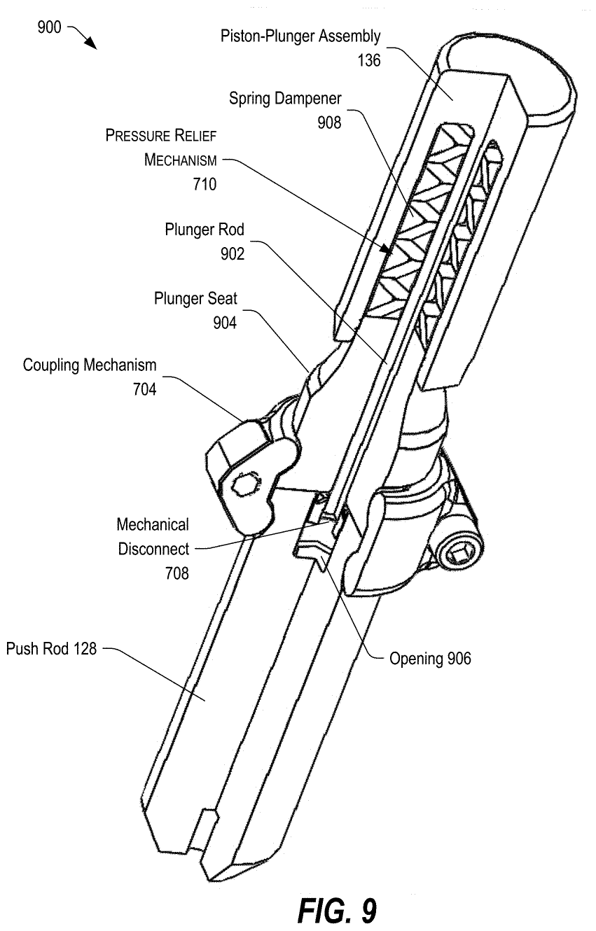

FIG. 9 depicts a piston-plunger assembly 900 including mechanical disconnect (coupling mechanism 704), peak pressure disconnect (mechanical disconnect 708), and damping mechanism (pressure relief mechanism 710), in accordance with certain embodiments of the present disclosure. The piston-plunger 136 is coupled to the push rod 128 by a coupling mechanism 704. In the illustrated example, the piston-plunger 136 includes a plunger seat 904 configured to fit over the end of the push rod 128. A plunger rod 902 may extend from an end of the piston-plunger assembly 136 and into an opening 906 within an end of the push rod 128.

Further, the piston-plunger assembly 136 may include an integrated pressure relief mechanism 710, which may include a spring dampener 908. In one possible example, the spring dampener 908 can include a plurality of springs or spring washers (such as Belleville washers), which may be stacked to form a spring-like structure that may flex in response to pressure, dampening vibrations. Other implementations are also possible.

In response to pressures from the piston cylinder 706 that exceed a threshold pressure, the mechanical disconnect 708 may break or otherwise cause the push rod 128 to disengage the piston-plunger assembly 136. Otherwise, during operation, the spring dampener 908 may dampen vibrations through the piston-plunger assembly 136, reducing impact vibrations that might otherwise be imparted to the power end 122. Other implementations are also possible.

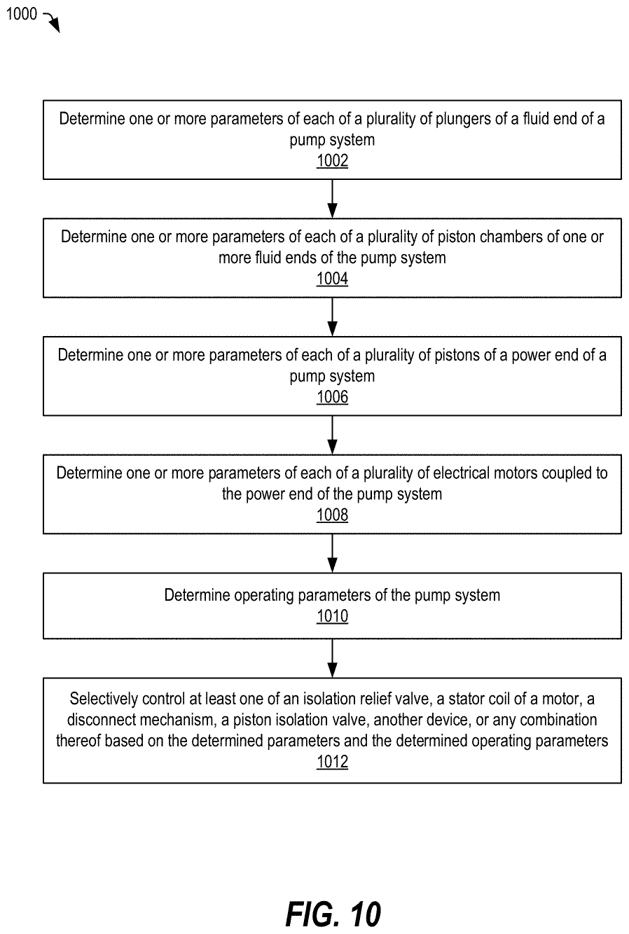

FIG. 10 depicts a flow diagram of a method 1000 of controlling a pump system, in accordance with certain embodiments of the present disclosure. At 1002, one or more parameters are determined for each of a plurality of plungers 136 of the one or more fluid ends 124 of a pump system 102. For example, the QQ system controller 110 may receive a plurality of sensor signals and may determine the one or more parameters based on the sensor signals.

At 1004, one or more parameters may be determined for each of the plurality of piston chambers 706 of one or more fluid ends 124 of the pump system 102. For example, the QQ system controller 110 may receive a plurality of sensor signals and may determine the one or more parameters based on the sensor signals.

At 1006, one or more parameters may be determined for each of the plurality of push rods 128 of the power end 122 of the pump system 102. For example, the QQ system controller 110 may receive a plurality of sensor signals and may determine the one or more parameters based on the sensor signals.

At 1008, one or more parameters may be determined for each of the plurality of electrical motors 118 coupled to the power end 122 of the pump system 102. For example, the QQ system controller 110 may receive a plurality of sensor signals and may determine the one or more parameters based on the sensor signals. In some implementations, the QQ system controller 110 may communicate with one or more power wedge controllers 222 to determine the parameters.

At 1010, the operating parameters of the pump system 102 are determined. The operating parameters may include settings and configuration details provided by a control system or determined by the load 116. Other implementations are also possible.

At 1012, at least one of an isolation relief valve, a stator coil of a motor, a disconnect mechanism, a piston isolation valve, another device, or any combination thereof may be selectively controlled based on the determined parameters and the determined operating parameters. The QQ system controller 110 may open valves, close valves, change operating speeds of the motors 118, adjust RPMs of the shaft 120, and initiate disconnection of the push rod 128 from the piston-plunger 136 based on the parameters. Other implementations are also possible.

In conjunction with the systems, methods and devices described above with respect to FIGS. 1-10, a QQ pump system may include a multiplicity of low speed, high torque direct drive electrical motors, driving a multiplicity of banks of positive displacement pistons called fluid-ends 122, through a novel rotary to linear conversion mechanism, referred to as a power end 124. In one embodiment, the QQ pump system may include multiple motors, driving multiple fluid ends 124. The combination of pressure and flow-rate output from the fluid ends 124 may define a primary specification in terms of hydraulic horsepower (HHP). The QQ pump system may be configured to deliver more than 21,000 HHP in a single unit measuring approximately 108×160×72 inches and weighing less than 50,000 lbs. There are many benefits derived from the compact nature of the system, enabled by a number of advantages.

One particular advantage includes the relatively low maintenance requirements of the direct drive motors and the power end 122, especially compared to the number of large diesel engines, transmissions, reduction gears and conventional power-ends replaced hereby. Further, the QQ pump system 102 may include a distributed system controller that may enable local, fast control of individual components. Additionally, the QQ pump system 102 may provide for fail-over, fault management, and dynamic load balancing, allowing the QQ pump system 102 to maintain consistent output pressure, even when individual pump components fail and are selectively deactivated. Other embodiments are also possible.

Although the present invention has been described with reference to preferred embodiments, workers skilled in the art will recognize that changes may be made in form and detail without departing from the scope of the invention.

What is claimed is:

1. A pump system comprises:
a shaft;
a plurality of motors coupled to the shaft and configured to cause the shaft to rotate about a longitudinal axis of the shaft;
a power end coupled to the shaft, the power end including a plurality of yoke frames, each yoke frame includes one or more push rods;
multiple fluid ends coupled to the power end, each fluid end including a cylinder chamber including a piston-plunger assembly configured to couple to one of the one or more push rods of the power end; and
one or more devices to independently load or unload one or more of the fluid ends.

2. The pump system of claim 1, further comprising a system controller to communicate with the one or more devices that are distributed within one or more of the plurality of motors, the power end, and the multiple fluid ends, the plurality of components configured to communicate with one another and to adjust one or more parameters to manage health of the pump system.

3. The pump system of claim 1, wherein the power end comprises:
the plurality of yoke frames, each yoke frame including:
a first push rod along a first edge of the yoke frame;
a second push rod along an opposing edge of the yoke frame; and
an opening;
a plurality of bushings, each bushing sized to fit within the central opening of one of the plurality of yoke frames, the bushing including a circular opening;
a plurality of eccentrics, each eccentric including an opening sized to fit onto the shaft, the opening offset from a center of the eccentric, the eccentric sized to fit within the circular opening of the bushing; and
wherein rotation of the shaft causes the eccentric to rotate about the shaft, driving the bushing and causing the yoke frame to move back and forth along a path that is perpendicular to the axis.

4. The pump system of claim 1, wherein at least one of the shaft, some of the plurality of motors, the power end, the one or more push rods, the multiple fluid ends, and the piston-plunger assembly are comprised of high modulus composite materials.

5. The pump system of claim 1, wherein the piston-plunger assembly includes damping mechanism to dampen shocks from the cylinder chamber to the yoke frame.

6. The pump system of claim 1, further comprising a coupling mechanism to couple the piston-plunger assembly to one of the plurality of push rods.

7. The pump system of claim 6, further comprising a disconnect mechanism to decouple the piston-plunger assembly from the one of the one or more push rods in response to a cylinder pressure that exceeds a threshold pressure.

8. The pump system of claim 1, further comprising:
a plurality of relief valves, each relief valve associated with one of the fluid ends and configured to couple the fluid end to a low pressure inlet;
wherein the one or more devices activate the relief valve to deliver fluid from the cylinder chamber to the low pressure inlet.

9. The pump system of claim 1, further comprising:
a first valve to couple a fluid inlet to the cylinder chamber;
a second valve to couple a fluid outlet to the cylinder chamber; and
wherein the one or more devices activate at least one of the first valve or the second valve to isolate the cylinder chamber from at least one of the fluid inlet or the fluid outlet.

10. The pump system of claim 1, further comprising a system controller including a plurality of inputs to receive sensor data, the system controller to selectively control one of a plurality of valves, a cooling subsystem, the plurality of motors, the power end, the one or more devices, and the multiple fluid ends in response to the sensor data.

11. The pump system of claim 1, further comprising an isolation valve responsive to the one or more devices to isolate a bank of fluid ends of the multiple fluid ends from a fluid inlet.

12. A pump system comprises:
a power end including a plurality of yoke frames, each yoke frame including one or more push rods;
a plurality of fluid ends coupled to the power end, each fluid end including a cylinder chamber and including a piston-plunger assembly within the cylinder chamber, each piston-plunger assembly to couple to a push rod of one of the plurality of yoke frames; and
a controller system to selectively unload one or more of the plurality of fluid ends.

13. The pump system of claim 12, wherein the piston-plunger assembly includes damping mechanism to dampen shocks.

14. The pump system of claim 12, further comprising:
a plurality of coupling mechanisms, each coupling mechanism to couple a push rod of the one or more push rods to the piston-plunger assembly of one of the plurality of fluid ends; and
a disconnect mechanism to decouple the piston-plunger assembly from the push rod in response to a cylinder pressure that exceeds a threshold pressure.

15. The pump system of claim 12, further comprising:
a plurality of relief valves, each relief valve associated with one of the plurality of fluid ends;
wherein the controller system selectively activates the relief valve of a selected one of the plurality of fluid ends to deliver fluid from the cylinder chamber of the selected one to a low pressure inlet.

16. The pump system of claim 12, further comprising:
a plurality of isolation valves;
wherein:
each fluid end includes:
a first valve between a fluid inlet and the cylinder chamber; and
a second valve between the cylinder chamber and a fluid outlet; and
the controller system selectively activates at least one of the first valve or the second valve to isolate the cylinder chamber.

17. The pump system of claim 12, wherein the controller system includes a plurality of inputs to receive sensor data, the controller system to selectively control at least one of a plurality of valves, a plurality of motors, and a plurality of push rod disconnect mechanisms in response to the sensor data to reduce pressure on one or more of the plurality of fluid ends.

18. The pump system of claim 12, further comprising an isolation valve responsive to the device to isolate a set of the plurality of fluid ends from a fluid inlet.

19. A pump system comprising:
a power end coupled to a shaft, the power end including a plurality of yoke frames, each yoke frame includes a plurality of push rods;
a plurality of fluid ends coupled to the power end, each fluid end including a cylinder chamber including a piston-plunger assembly to couple to a push rod of the plurality of push rods via a coupling mechanism, the piston-plunger assembly including an integrated damping feature to dampen vibration; and
a first mechanism to decouple the piston-plunger assembly from the one of the plurality of push rods in response to a cylinder pressure that exceeds a threshold pressure;
a second mechanism to isolate the cylinder chamber from at least one of a fluid inlet and a fluid outlet; and
a system controller to communicate with the power end, the plurality of fluid ends, the first mechanism, and the second mechanism, the system controller to adjust one or more parameters to manage health of the pump system.

20. The pump system of claim 19, wherein the second mechanism comprises:
a first valve between the fluid inlet and the cylinder chamber;
a second valve between the fluid outlet and the cylinder chamber; and
a third valve between a fluid source and one of the plurality of fluid ends;
wherein the system controller controls one of the first valve, the second valve, and the third valve to selectively unload one of the cylinder chamber and the fluid end.
